(19) United States
(12) Patent Application Publication
(10) Pub. No.: US 2025/0173403 A1
(43) Pub. Date: May 29, 2025

(54) TRANSFORMER BLOCK BASED OBFUSCATION

(71) Applicant: Protopia AI, Inc., Austin, TX (US)

(72) Inventors: Clint Solomon Mathialagan, Austin, TX (US); Kyle A. Mylonakis, Austin, TX (US)

(21) Appl. No.: 18/962,738

(22) Filed: Nov. 27, 2024

Related U.S. Application Data
(60) Provisional application No. 63/603,061, filed on Nov. 27, 2023.

(51) Int. Cl. G06F 21/10

(52) U.S. Cl. CPC G06F 21/1066

(57) ABSTRACT

Provided are methods and systems for obtaining, by a computer system, a machine learning model, the machine learning model comprising at least one transformer block; generating, by the computer system, one or more estimator based on the at least one transformer block, wherein at least one estimator comprises a mean shift estimator; and wherein at least one estimator comprises a dispersion shift estimator; training, by the computer system, the one or more estimators to obfuscate input data for the machine learning model; and storing, by the computer system, the trained one or more estimators in memory.

### TECHNICAL FIELD

This disclosure relates generally to the field of security in machine learning models and more particularly to input obfuscation for machine learning models.

### BACKGROUND

Machine learning models, including foundation modals, generative models, etc., may be provided (e.g., owned, maintained, provided, etc.) by an entity (e.g., a model-holder) which allows other entities (e.g., model-user) to provide data to the model (e.g., an instance of the model, a quantized version of the model, a static version of the model, a customized version of the model, etc.), such as through a licensing agreement, via an open-source arrangement, etc. The model-user may supply customer data to the machine learning model, such as training data, inference data, etc., which may include sensitive data—e.g., proprietary data, protected data, trade secrets, etc.—which the model-user may have a reason (e.g., legal, ethical, contractual, commercial, etc.) to protect (for example, obfuscate), for example from the model-holder, the model itself, other instances of the model (e.g., in cases of data spill over), other users of the model, other entities (e.g., adversarial entities) which may be able to view input to or output from the model, etc. The model-user may wish to obfuscate the data they provide, such as in the form of obfuscated model input, especially for transfer over untrusted networks or thought models outside of trusted envelopes.

### SUMMARY

The following is a non-exhaustive listing of some aspects of the present techniques. These and other aspects are described in the following disclosure.

Some aspects include application one or more estimators to apply obfuscation to input data for a machine learning model.

Some aspects include training of one or more estimators to apply obfuscation to input data for a machine learning model.

Some aspects include estimators generating using transformer block architecture.

Some aspects include a tangible, non-transitory, machine-readable medium storing instructions that when executed by a data processing apparatus cause the data processing apparatus to perform operations including the above-mentioned application.

Some aspects include a system, including: one or more processors; and memory storing instructions that when executed by the processors cause the processors to effectuate operations of the above-mentioned application.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 depicts an example estimator configuration, in accordance with some embodiments;

FIG. 2 depicts an example estimator configuration for use with distillation training, in accordance with some embodiments;

FIG. 3 illustrates an exemplary method for training input obfuscation based on a transformer block for a machine learning model, in accordance with some embodiments;

FIG. 4 shows an example computing system that applied input obfuscation in a machine learning model, in accordance with some embodiments; and

FIG. 5 shows an example computing system that may be used in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of machine learning and data privacy. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Users of machine learning models—e.g., model-users—may be entities which supply data to a machine learning model. In some embodiments, the model-user may control (e.g., own, operate, etc., such as within a trusted network) the entirety or a portion of the machine learning model to which they supply data. For example, the model-user may be the model-holder (e.g., an entity which owns, operates, etc. the machine learning model, including having access to view and change parameters of the machine learning model, including hidden layers). In some embodiments, the model-user may have access to the machine learning model, but may not control the machine learning model. For example, the model-user may have exclusive or non-exclusive access to input data into a machine learning model (for example, a cloud-based model, an open-source model, a proprietary model held by a second entity) and receive output data in response, but may not have access to the model architecture, parameters, hidden layers, etc. In some embodiments, the model-user may have access, where access may include access to view or access to view and change, to a portion (e.g., layers, architecture, etc.) of a machine learning model. For example, a machine learning model may have a known architecture, such as a known transformer block architecture—that is, architecture that is known to the model-user. In some embodiments, a transformer block architecture may include transformer blocks with one or more layer normalization (e.g., a layer norm), one or more self-attention (or multi-query attention or any other appropriate model of attention) mechanism, a feed forward mechanism (or any other appropriate flow mechanism), etc. In some embodiments, the machine learning model may be made up of a number of repeats (e.g., up to 10, 100, 1,000, 10,000, 100,000, 1,000,000, or more repeats) of a transformer block, which may be an identical transformer block in some embodiments. In some embodiments, the transformer block may vary, including substantially in architecture or parameters, between layers. A model-user may have access to one or more transformer blocks of the machine learning model, including with the architecture used in the machine learning model, with or without trained weights or other parameters.

In some embodiments, the machine learning model may be causal. That is, the machine learning model or at least some of its constituent parts, layers, mechanisms, etc. (for example, the transformer blocks) may be causal. Causal models and mechanisms may operate on previous data to generate subsequent data (e.g., on past events to predict future events, on input tokens to generate output tokens in a text or other sequence, etc.). In some embodiments, causality may be introduced or enhanced through the use of an attention mechanism, such as self-attention, though the use of a flow mechanism, such as by a feedforward mechanism, etc. In some embodiments, some parts of the machine learning model, such as some transformer blocks, may be causal, while other parts of the machine learning model may be non-causal (for example, forward and backward looking). In some embodiments, the machine learning model, such as when taken as a whole, may be causal, but some parts of the machine learning model, such as when extracted from the model as a whole, may be non-causal.

At various points in data transit, such as from data acquisition apparatuses (for example, client mobile device, security camera, etc.) to the model-user (for example, via mobile applications, APIs, etc.) or from the model-user to the model-holder (for example, via cloud-based data transfer, via cellular network, etc.), the data may be vulnerable to interception by untrusted networks, devices, entities, adversaries, etc.—even if the model-user is the model-holder. In some embodiments, input to a machine learning model may be or contain sensitive data—e.g., proprietary data, protected data, trade secrets, etc.—which the model-user may have a reason (e.g., legal, ethical, contractual, commercial, etc.) to protect (for example, obfuscate), including from interception or from interpretation if intercepted. Because the data may be vulnerable, e.g., when travelling outside a trusted envelope, a model-user may obfuscate the data at one or more junctures to protect the privacy of the data. In some embodiments, obfuscation may encompass both data (e.g., user data) and the model-user's operation(s) upon the data (for example, a prompt supplied with the data). In some embodiments, the data may be in an obfuscated state when it is operated on by a machine learning model held by a model-holder (which may or may not be trusted) or transmitted over or to untrusted networks or models. In some embodiments, the data may be un-obfuscated when it is operated on by trusted machine learning models or transmitted over trusted networks.

The terms “trusted” and “untrusted” are not used in the subjective sense, and no state of mind or judgement is required. Rather the terms refer to distinct computing environments where privileges in one do not necessarily afford full access in the other. A descriptor of “untrusted” does not imply that an entity be adversarial, but rather instead includes cases where an entity may be trusted under certain conditions or to a certain extent (such as under contractual obligation of a model-holder to a model-user), but who, for reasons such as conflict of interest, data-breach protection, obligations to other model-users, etc., an entity treats as untrusted at least part of the time the model is used. For example, in some cases a machine learning model belonging to a model-holder may be treated as trusted during some time periods, such as during training—which may occur on a trusted network—but may be treated as untrusted during deployment—which may occur over an untrusted network.

In some embodiments, one or more estimators may be used to apply an obfuscation to data (e.g., input data for a machine learning model). In some embodiments, the data may be mid-steam data, such as data transmitted from one machine learning model (such as in an ensemble) or part of a machine learning model (such as a machine learning model operating in different locations) to another machine learning model or another part of the machine learning model. For example, the data may be data output by a model head and transmitted to the remaining parts of the machine learning model, where the model head may be on a trusted network and the remaining parts of the machine learning model may be on an untrusted network. As used hereafter, “input data” may be data input into a machine learning model or estimator and may have already been subject to processing, such as tokenization, translation to embeddings, smoothing, etc. In some embodiments, the one or more estimators may be neural networks (NNs) or parts thereof, which may apply obfuscation to data, embeddings corresponding to data, tokens, etc. In some embodiments, a first estimator may apply a transformation to act as a mean shift to be applied to input data (e.g., input data to the estimator, such as to embeddings corresponding to data input at any stage). In some embodiments, a second estimator may determine (e.g., characterize) a distribution, with or without mean distribution, (e.g., by determining a standard deviation or another distribution characterization parameter for the input data received at the estimator) and use the distribution to apply noise, such as stochastic noise, to the input data (e.g., to embeddings, tokens, etc.) to generate noise (e.g., obfuscating noise in embeddings corresponding to the input data). The descriptors “first” and “second” are used only to differentiate the estimators for case of description, not to imply importance, order, frequency of use, size, etc. In some embodiments, the first estimator may be used without the second estimator or may apply significantly more shift to the input data than the second estimator. In some embodiments, the second estimator may be used without the first estimator or may apply significantly more shift to the input data than the first estimator. In some embodiments, both the first and second estimator may be used, which may apply shifts of similar or significantly different sizes and directions. By shifting a mean of the input data or applying noise on the distribution of the input data (e.g., on the standard deviation), the input data may be obfuscated. By training the estimators, such as by using a machine learning model and a model output accuracy optimization function or any other appropriate method, mean and distribution estimators may be determined which may obfuscate the input data while preserving the quality of output of the machine learning model. In some embodiments, the estimators may be NNs which operate on the input data (or embeddings thereof), including dependently or independently of one another, to generate embeddings with shifted mean and distribution from the input data. In some embodiments, the one or more estimators may apply deterministic noise to the mean of the embeddings. In some embodiments, the one or more estimators may apply stochastic noise to the distributions (e.g., standard deviation) of the embeddings.

In some embodiments, the estimators may correspond to, such as by using architecture of, one or more transformer blocks of the machine learning model. In some embodiments, the estimators may correspond to transformer blocks significantly identical to one or more of the transformer blocks of the machine learning model, which may be the machine learning model for which the estimators are trained to provide obfuscation. In some embodiments, the estimators may have substantially the same architecture as a first transformer block of the machine learning model (or another appropriate reference model). In some embodiments, the estimators may have substantially the same architecture and weights as the first transformer block of the machine learning model, but may have different attention or flow mechanisms than the first transformer block of the machine learning model. For example, the estimators may have non-causal attention mechanisms. In some embodiments, the estimators may have substantially the same architecture or weights as any other appropriate transformer block, such as the second transformer block, the i-th transformer block (where 2<i<N), the last transformer block (e.g, Nth or Mth transformer block), etc.

In some embodiments, the machine learning model may be an ensemble of machine learning models. In some embodiments, the machine learning model may be a large language model (LLM). In some embodiments, the machine learning model may be a LLaMa model. In some embodiments, the machine learning model may be a LLAMA 2 model, or any other LlaMa model, such as LLAMA 3.1, LLAMA 3.2, Hermes 3, Mistral 7B v0.2, etc. In some embodiments, the machine learning model may be any appropriate autoregressive LLM. In some embodiments, the machine learning model may be an LLM made up of multiple repeating blocks, where such blocks may include transformer architecture (e.g., may be transformer blocks). In some embodiments, the machine learning model may be a natural language processing (NLP) model. In some embodiments, the machine learning model may be an open-source model. In some embodiments, the machine learning model may have some open-source components, such as architecture, a token dictionary, etc. and other components, such as weights, which are trained, proprietary, non-open-source, or otherwise not readily available to non-model-holders. In some embodiments, the machine learning model may be a non-open-source model, such as a proprietary model, licensed model, etc., which the model-user may have permission to use and for which the model-user may or may not know the architecture. In some embodiments, the machine learning model may be held by the model-user (e.g., the model-user may be the model-holder. In some embodiments, the machine learning model may be a generative model, including a generative language model, a generative image model, etc. In some embodiments, the machine learning model may accept multiple inputs, which may include prompts, of any appropriate type. In some embodiments, the input to the machine learning model (such as a generative image model, foundational model, etc.) may substantially be a prompt.

In some embodiments, input to the machine learning model may be obfuscated in one or more ways. Training data may be obfuscated. Deployed data may be obfuscated. Inference data may be obfuscated. Input data may be obfuscated by any appropriate manner. Data may be obfuscated in one or more way, such as by methods including obfuscations trained by self-supervision as are described in U.S. patent application Ser. No. 18/303,454, titled SELF-SUPERVISED DATA OBFUSCATION IN FOUNDATION MODELS, filed 19 Apr. 2023, (describing obfuscation operations and data obfuscation in reference to foundation models, including language models), by conditional noise (e.g., obfuscation) layers as are described in U.S. patent application Ser. No. 18/114,165, titled CONDITIONAL NOISE LAYERS FOR GENERATING ADVERSARIAL EXAMPLES, filed 24 Feb. 2023 (describing conditional noise layers), by obfuscations trained by limited supervision as are described in U.S. patent application Ser. No. 18/170,476, titled OBFUSCATION OF ENCODED DATA WITH LIMITED SUPERVISION, filed 16 Feb. 2023 (describing obfuscation of embeddings of input data), by generation of quasisynthetic data as are described in U.S. Provisional Patent Application 63/311,014, titled QUASISYNTHETIC DATA GENERATION FOR MACHINE LEARNING MODELS, filed 16 Feb. 2022 (describing generation of quasisynthetic input data suitable for use with machine learning models based on un-obfuscated input data), and by obfuscations trained by self-supervision as are described in U.S. Provisional Patent Application 63/420,287, titled SELFSUPERVISED DATA OBFUSCATION, filed 28 Oct. 2022 (describing data obfuscation operations) and U.S. patent application Ser. No. 18/303,454, titled SELF-SUPERVISED DATA OBFUSCATION IN FOUNDATIONAL MODELS, filed 19 Apr. 2023, the entire content of each of which is hereby incorporated by reference. Examples of noise distributions and stochastic gradient methods that may be used for data obfuscations, including input data obfuscations, distribution obfuscation, etc., are described in U.S. Provisional Patent Application 63/227,846, titled STOCHASTIC LAYERS, filed 30 Jul. 2021 (describing examples of stochastic layers with for data obfuscation); U.S. Provisional Patent Application 63/221,738, titled REMOTELY-MANAGED, NEAR-STORAGE OR NEAR-MEMORY DATA TRANSFORMATIONS, filed 14 Jul. 2021 (describing data transformations that may be used with the present techniques, e.g., on input data); and U.S. Provisional Patent Application 63/153,284, titled METHODS AND SYSTEMS FOR SPECIALIZING DATASETS FOR TRAINING/VALIDATION OF MACHINE LEARNING, filed 24 Feb. 2021 (describing examples of obfuscation techniques that may be used with the present techniques); each of which is hereby incorporated by reference. In some embodiments, input data may be obfuscated in a way that leaves the obfuscated data suitable for training a machine learning model or performing inference but conceals the un-obfuscated version of the training data. To train the obfuscator, some embodiments obtain training data, train a transformer on the training data, and may learn parameters of parametric noise distributions for inserted noise layers (e.g., applied by one or more estimators). The parametric noise distributions may be learned with the techniques described in U.S. patent application Ser. No. 17/458,165, filed 26 Aug. 2021, titled METHODS OF PROVIDING DATA PRIVACY FOR NEURAL NETWORK BASED INFERENCE, the contents of which are hereby incorporated by reference.

In some embodiments, a portion of a machine learning model may be obtained. The portion of the machine learning model which is obtained may be a single transformer block, multiple transformer blocks (e.g., two or more transformer blocks), N transformer blocks, etc. which may be less than half of the total machine learning model, less than a tenth of the total machine learning model, etc. If multiple transformer blocks are obtained, these transformer blocks may or may not be substantially As machine learning models grow in complexity and size, operating on a portion of the machine learning model instead of the entire machine learning model, such as provided for in some embodiments, may allow for flexibility in obfuscation while limiting the amount of computing power needed to determine obfuscation parameters (e.g., by operating on less than the whole machine learning model). In some embodiments, the size of the portion of the machine learning model which is obtained (e.g., the number of repeats of the transformer block) may depend on the architecture of the machine learning model. The portion of the machine learning model which is used to train the estimators for obfuscation may be or be a portion of a reference model. In some embodiments, the reference model may be a quantized version of the machine learning model (e.g., a quantized version of a portion of the machine learning model). The portion of the machine learning model may be a truncated version of the machine learning model. The portion of the machine learning model may be used, including by distillation, to train obfuscations (e.g., estimators to apply obfuscations) which may be applied to the machine learning model (e.g., the whole machine learning model) or data input into the machine learning model.

In some embodiments, the one or more estimators which apply the obfuscation on the input data (e.g., on embeddings corresponding to the input data) may have the same architecture as the transformer blocks of the machine learning model. In some embodiments, the architecture of multiple of the estimators may be the same—e.g., an estimator which applies a deterministic mean shift may have substantially the same architecture as an estimator which applies stochastic noise to a distribution (for example, to the standard deviation of the embeddings). In some embodiments, the estimators may have different architecture from one another or from the transformer blocks of the machine learning model. In some embodiments, an estimator which provides stochastic noise may have a simpler architecture (for example, fewer repeats) than an estimator which applied deterministic noise. In some embodiments, the estimators may have substantially the same architecture as one another, but different architecture than the transformer block. In some embodiments, one or more of the estimators may have substantially the same architecture as the transformer block, while another one or more of the estimators may have different architecture than the transformer block. In some embodiments, there may be two estimators. In some embodiments, there may be one estimator, such as an estimator which shifts a mean of embeddings or an estimator which applies stochastic noise to a distribution (e.g., standard deviation) of the embeddings. In some embodiments, the obfuscation may be applied by multiple transformer blocks, which may each have one or more estimators.

In some embodiments, the estimators may be trained, such as to maximize the obfuscation of the input data while minimizing the decrease in performance of the machine learning model on the obfuscated input data. The training may be based on a loss function, cost function, optimization function, or by any other appropriate manner. The training may be based on a privacy budget, a measurement of mutual information degradation between input and obfuscated input data, etc. The training may be performed by any appropriate method, such as gradient descent. The training may be based on a weighted sum of different optimization functions, including a linear combination of optimization functions, an alpha list of optimization functions (e.g., a list of optimization order), a weighted sum of optimization functions, etc., which may account for arbitrarily many optimization functions. In some embodiments, each estimator may be trained separately. In some embodiments, one or more estimators may be trained together, including concurrently, sequentially, alternatively, in series, using coordinated descent, etc. In some embodiments, each estimator may have a separate corresponding optimization function. In some embodiments, the optimization functions of one or more estimators may be combined, such as during training. In some embodiments, training may include optimization of one or more transformer blocks of the machine learning model, including optimization of model architecture, parameters, etc. In some embodiments, a first layer (or layers) of the machine learning model may be optimized together with the estimators to customize the machine learning model for the obfuscation, for the task, for inference on the obfuscated data, for the model-user vs. the model-holder, etc.

In some embodiments, each estimator may function as a noise layer. In some embodiments, the one or more estimators may function as a single noise layer. In some embodiments, the one or more estimators may function as multiple noise layers, or noise may be added at multiple layers in a NN of the estimator. In some embodiments, the noise layer may generate additive noise. Noise may be any appropriate type of obfuscating noise, such as stochastic noise, additive noise, multiplicative noise, mean shift noise, distribution shift noise, distribution expansion noise, etc.

In some embodiments, the machine learning model may be a foundational model. In some embodiments, the machine learning model may be any parameterized model. In some embodiments, the machine learning model may have a transformer block architecture of a number M of repeats. In some embodiments, the machine learning model may be an LLM. In some embodiments, the machine learning model may be an image processing model. The machine learning model may be any appropriate machine learning model, operating on any appropriate type of input data. In some embodiments, the input data may have a sequence dependency. For example, for input data of an LLM, the order of tokens in the input data may be input into the model, such as by inputting the tokens in order (e.g., a sequence), such as by providing positional embeddings, etc. In some embodiments, the estimators may operate on the tokens of the input data (e.g., embeddings) as a sequence of embeddings for obfuscation. In some embodiments, the estimators may or may not operate upon positional embeddings in input data, such as where positional embeddings make up certain portions of embeddings (e.g., certain dimensions of vectors of embeddings). In some embodiments, the obfuscation may be sequence dependent. In some embodiments, a set of obfuscation elements is applied (e.g., by the estimators) at inference. In some embodiments, the estimators may apply obfuscation to the input data at inference time. In some embodiments, the estimators may precompute a set of obfuscation elements which are then applied to the input data at inference time. In some embodiments, the obfuscation elements may be looped, such as in cases where the input data contains a sequence longer than a precomputed string of obfuscation elements. The obfuscation may be applied when input data leaves a trusted network for an untrusted network (e.g., prior to transmission).

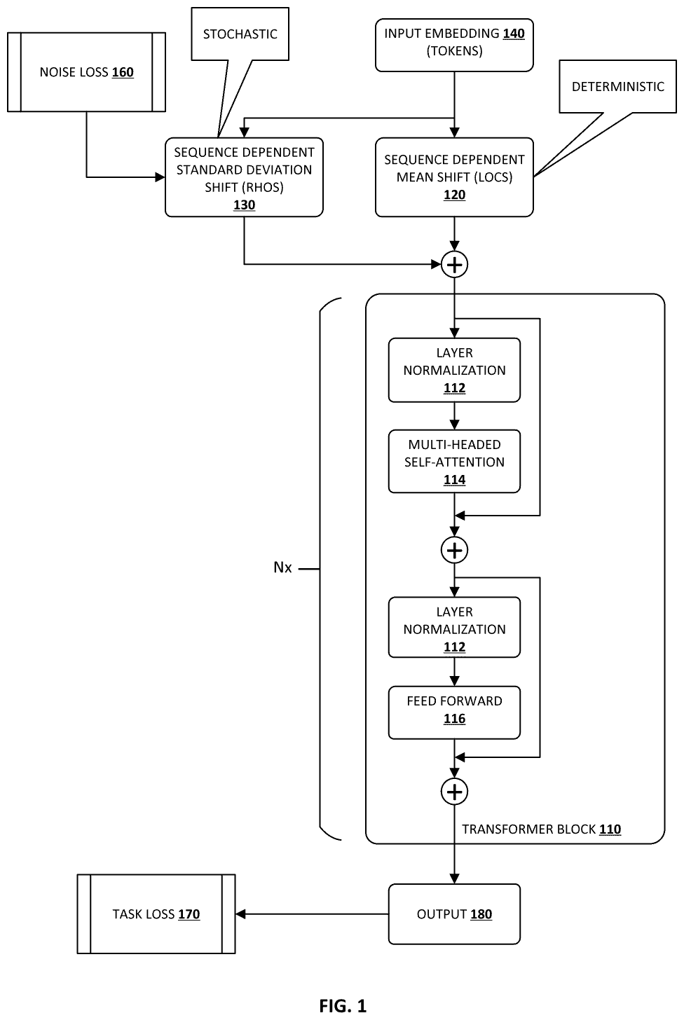

FIG. 1 depicts an example estimator configuration, in accordance with some embodiments. A machine learning model contains a number M of transformer blocks. A number N of transformer blocks 110 may be extracted from the machine learning model to form a truncated machine learning model, where N≤M. Each transformer block 110 may contain any appropriate architecture, including one or more layer normalization 112, one or more attention mechanism (such as multi-headed self attention mechanism 114), one or more flow mechanism (such as feed forward mechanism 116), and any other appropriate layers and mechanisms. A set of one or more estimators may be trained to apply obfuscation to input data for the machine learning model based on the truncated machine learning model or reference model (e.g., of N transformer blocks). A deterministic estimator 120 may be trained to apply noise to a mean of embeddings of input data (e.g., as a sequence dependent mean shift). In some embodiments, the deterministic estimator 120 may apply noise to the mean of embeddings as additive noise, subtractive noise, etc. The deterministic estimator 120 may apply noise which shifts values of substantially all of the embeddings by a substantially uniform amount. A stochastic estimator 130 may be trained to apply noise based on the distribution (e.g., the standard deviation) of the embeddings of the input data (e.g., as a sequence dependent standard deviation shift). In some embodiments, the stochastic estimator 130 may determine a distribution of the embeddings (for example, a standard deviation) and generate a noise distribution based on the distribution of the embeddings—such as by applying noise based on the determined standard deviation to each embedding to generate a realistic (e.g., corresponding to the determined distribution) but obfuscated embedding. For example, the noise distribution, such as corresponding to the distribution of the embeddings, may then be sampled from, with sampled noise applied to embeddings in some embodiments. In some embodiments, the stochastic estimator 130 may apply noise which increases the standard deviations of the embeddings (e.g., of the values of the embeddings), while preserving the mean (e.g., of the distribution of values of the embedding). The distribution of the stochastic noise may or may not be of a similar shape (e.g, Gaussian, Laplacian, etc.) as the determined distribution of the input data. The distribution of the stochastic noise may or may not have the same dispersion as the determined distribution of the input data.

Each estimator (e.g., deterministic estimator 120 and stochastic estimator 130) may operate independently on text embeddings 140 of the input data (or other appropriate representations of the input data, such as tokens, or whatever embeddings are appropriate for input data which may be composed of text, images, auditory sequences, etc.). One or more optimization functions may be used to train the estimators, including a noise optimization function (e.g., a noise loss 160), a task optimization function (e.g., a task loss 170), etc. The task optimization function may be determined based on performance of the truncated machine learning model, the full machine learning model, etc., such as by performance on output 180, which may be obfuscated data, output of the machine learning model on obfuscated data, etc. In some embodiments, the noise optimization function may be maximized while the task optimization function is minimized. In some embodiments, the noise optimization function may measure the amount (e.g., intensity) of the applied noise. In some embodiments, the noise optimization function may measure a similarity (or conversely a dissimilarity) between noise embeddings (e.g., embeddings to which noise has been applied) and original embeddings (e.g., embeddings as supplied to an obfuscation transformation). In some embodiments, the noise optimization function may measure a similarity between input data and obfuscated data, where data may or may not be treated as embeddings, including based on one or more transformations between embeddings and un-embedded (e.g., pre-embedding) data. As referred to herein, an optimization function may be or include a loss function in some embodiments. In some embodiments, an optimization function may be a cost function. In some embodiments, only one estimator may be used and either the deterministic estimator 120 or stochastic estimator 130 may be omitted. In some embodiments, multiple of either or both of the deterministic estimator 120 and stochastic estimator 130 may be used. In some embodiments, any appropriate additional estimator(s) may be used, or noise may be applied multiple times or in multiple places by one or more estimators. In some embodiments, noise may be applied by one or more estimator and additionally by any other described method, such as those described in the patent documents incorporated by reference as previously described.

In some embodiments, such as depicted in FIG. 1, noise (e.g., stochastic noise applied as a sequence-dependent standard deviation shift) may be applied at a block shown as the stochastic estimator 130, which may be named rhos, but which may be any appropriate transformer architecture. In some embodiments, noise may be applied in any appropriate manner. In some embodiments, noise loss, such as noise loss 160, may be determined based on a mean squared noise term or any other appropriate norm. In some embodiments, noise loss may be any appropriate noise optimization function. In some embodiments, such as depicted in FIG. 1, noise (e.g., deterministic noise applied as a sequence-dependent mean shift by the deterministic estimator 120) may be applied as a block, which may be named locs, but which may be any appropriate transformer architecture. In some embodiments, deterministic noise may be applied in any appropriate manner. In some embodiments, task loss, such as task loss 170, may be determined as a squared-error loss. In some embodiments, task loss may be any appropriate task optimization function.

In some embodiments, such as depicted in FIG. 1, noise loss, such as noise loss 160, may be determined—and noise applied—based on the output of one estimator (e.g., the stochastic estimator 130 trained to apply noise to the distribution (e.g., to the standard deviations) of the embeddings). In some embodiments, noise loss may be determined based on the output of multiple estimators (e.g., both the stochastic estimator 130 and the deterministic estimator 120) or on the entire embedding (such as after the merge of the output of multiple estimators). In some embodiments, noise loss may be determined based on the output of less than all estimators (for example, based on the output of two out of four estimators), including based on embeddings generated by combinations of estimator(s), (e.g., by merging, by sequential application of estimators, etc.).

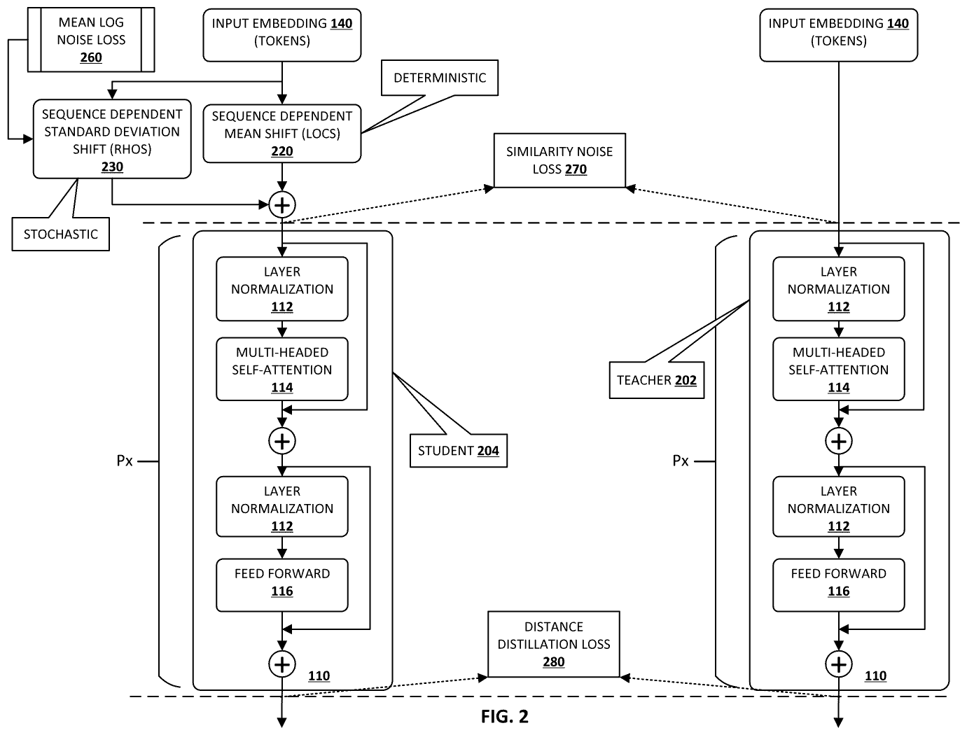

FIG. 2 depicts an example estimator configuration for use with distillation training, in accordance with some embodiments. FIG. 2 is described in relation to some parts also contained in FIG. 1, which are referenced by the same numbers and may be any appropriate parts such as previously described. In some embodiments, a machine learning model contains a number M of transformer blocks. A number P of transformer blocks may be extracted from the machine learning model as a truncated model, where P≤M. A teacher machine learning model 202 and a student machine learning model 204 may each be formed with the form of the truncated machine learning model. The student machine learning model 204 may be adjusted, while the teacher machine learning model 202 may remain as the truncated machine learning model, including in order to allow for optimization of the estimators. A deterministic estimator 220 may be trained to apply noise to a mean of embeddings of input data (e.g., as a sequence dependent mean shift). The deterministic estimator 220 may be any appropriate deterministic mean shift estimator, such as deterministic estimator 120 of FIG. 1 as previously described. A stochastic estimator 230 may be trained to apply noise based on the distribution (e.g., the standard deviation) of the embeddings of the input data (e.g., as a sequence dependent standard deviation shift). The stochastic estimator 230 may be any appropriate stochastic standard deviation shift estimator, such as the stochastic estimator 130 of FIG. 1 as previously described. In some embodiments, the stochastic estimator 230 may determine a distribution of the embeddings (for example, a standard deviation) and generate a noise distribution based on the distribution of the embeddings. The noise distribution, corresponding to the distribution of the embeddings, may then be sampled from, with sampled noise applied to embeddings in some embodiments. In some embodiments, the stochastic estimator 230 may apply noise which increases the standard deviations of the embeddings (e.g., of the values of the embeddings), while preserving the mean. In some embodiments, each estimator may operate independently on text embeddings of the input data (or other appropriate representations of the input data, such as images, auditory sequences, etc.). One or more optimization functions may be used to train the estimators, including a noise optimization function (e.g., a noise loss 260), a similarity optimization (e.g., a similarity noise loss 270), a distance distillation optimization (e.g., a distance distillation loss 280), etc. In some embodiments, one or more optimization functions may be loss functions. In some embodiments, an optimization function may be a cost function. The noise optimization function may be a log noise loss function, such as a mean log noise loss shown as noise loss 260, or any appropriate noise loss optimization function. The similarity optimization, which may be the similarity noise loss 270, may be a cosine similarity function or any appropriate similarity optimization function (or norm). The similarity optimization function may operate to minimize the similarity between input obfuscated by the estimators and input not obfuscated by the estimators. The similarity optimization function may be a measure of mutual information or similarity, which may operate to minimize similarity (as measured in any appropriate way) between the input obfuscated by the estimators and input not obfuscated by the estimators. A distance distillation optimization function, which may be the distance distillation loss 280, may be a cosine difference function or any appropriate difference optimization function (or norm). The distance distillation function may operate to maximize the similarity (e.g., minimize the difference) between the output of the truncated student machine learning model for the obfuscated data and the output of the truncated teacher machine learning model operating on the data (e.g., un-obfuscated data). A task optimization function may or may not be included in the optimization function. In some embodiments, the task optimization function may be a task loss function. In some embodiments, the task optimization function may be determined based on an untruncated model. The noise optimization function may be maximized while the similarity loss (e.g., a noise loss function, which may decrease as a function of increased applied noise, may be minimized) and distance distillation loss is minimized. In some embodiments, the noise optimization function and the distance distillation loss function may be computed independently, such as by alternating optimization, sequential optimization, etc. In some embodiments, the noise optimization function and the distance distillation loss function may be computed dependently or as part of a larger optimization function and co-optimized concurrently. In some embodiments, only one estimator may be used and either the mean or standard deviation estimator may be omitted. In some embodiments, additional estimators may be used, or noise may be applied multiple times or in multiple places by one or more estimators.

In some embodiments, such as depicted in FIG. 2, noise loss 260 may be determined—and noise applied—based on the output of one estimator (e.g., the stochastic estimator 230 trained to apply noise to the distribution (e.g., to the standard deviations) of the embeddings). In some embodiments, noise loss 260 may be determined based on the output of multiple estimators (e.g., both the stochastic estimator 230 and the deterministic estimator 220) or on the entire embedding (such as after the merge of the output of multiple estimators). In some embodiments, noise loss 260 may be determined based on the output of less than all estimators (for example, based on the output of two out of four estimators), including based on embeddings generated by combinations of estimator(s), (e.g., by merging, by sequential application of estimators, etc.). In some embodiments, such as depicted in FIG. 2, noise loss 260 (e.g., similarity noise loss) may be determined based on the output of multiple estimators, including based on the combination (e.g., merging) of output of multiple estimators. In some embodiments, the noise loss 260 (e.g., similarity noise loss) may be determined at the interface between a trusted network and an untrusted network, for example where embeddings leave a client-side server to be transmitted to a machine learning model (e.g., from the network of the model-user or data-holder to the network of the model-holder).

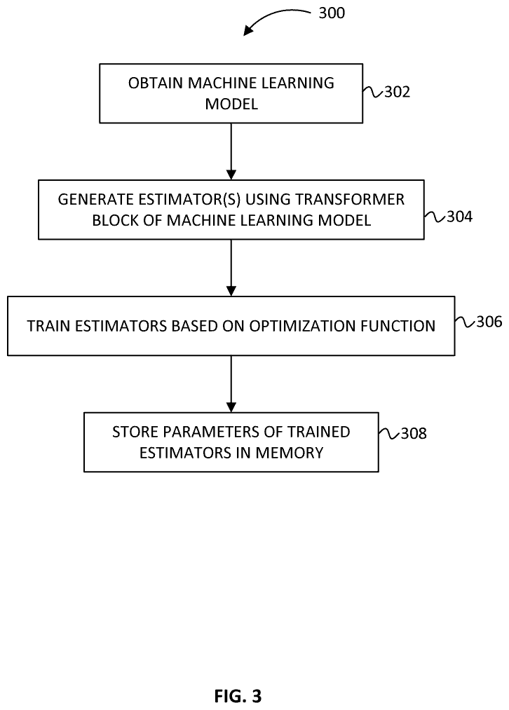

FIG. 3 illustrates an exemplary method 300 for training input obfuscation based on a transformer block for a machine learning model, in accordance with some embodiments. Each of these operations is described in detail below. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting. In some embodiments, one or more portions of method 300 may be implemented (e.g., by simulation, modeling, etc.) in one or more processing devices (e.g., one or more processors). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300, for example.

At an operation 302, a machine learning model is obtained. The machine learning model may be any appropriate machine learning model including transformer architecture. The machine learning model may be an LLM, an image model, a voice recognition model, etc. The machine learning model may be any appropriate model, ensemble of models, or part of model (e.g., truncated model) such as previously described. The machine learning model may operate on sequential input data, including embeddings, tokens, etc. The machine learning model may be a foundational model. The machine learning model may be a generative model. The machine learning model may be obtained in full or in part. The machine learning model may be obtained as a transformer block or one or more transformer block obtained from the machine learning model. The machine learning model may be obtained as a truncated model.

At an operation 304, one or more estimators may be generated based on the obtained machine learning model. The estimators may have the same architecture as the transformer blocks of the machine learning model. The estimators may have simplified versions of the architecture of the transformer blocks. The estimators may be non-causal versions of transformer blocks, where the transformer blocks may be causal. The estimators may have the same or different parameters values as the transformer blocks of the machine learning model. The estimators may have the same or different architecture as each other. The estimators may have trained or untrained parameters in addition to architecture. The estimators may operate on the same type of input as the machine learning model or on one or more of multiple types of input the machine learning model operates on.

At an operation 306, the estimators may be trained (including retrained, additionally trained, etc.) based on the obtained machine learning model and input data. The input data may be a set of training data, e.g., supervised training data, which includes input data and output of the machine learning model for the input data. The input data may be a set of training data, e.g., unsupervised data, which includes input data but no output of the machine learning model for the input data. In some embodiments, the training data may be used, together with the obtained machine learning model in truncated or untruncated form, to train the estimators in a self-supervised or semi-supervised manner. In some embodiments, the estimators may be trained based on an optimization function which may maximize noise (in the obfuscated data with respect to the un-obfuscated data) and minimize loss (in the output of the machine learning model based on the obfuscated data with respect to the output of the machine learning model based on the un-obfuscated data). In some embodiments, a teacher-student distillation technique may be used. In some embodiments, the estimators may be trained based on an optimization function which minimizes distillation loss. The estimators may be trained independently or co-trained. The training may conclude when any appropriate termination criterion is reached.

At an operation 308, parameters of the trained estimators may be stored in memory. The trained estimators may be deployed, such as NNs, on a trusted network to obfuscate data for transmission by untrusted means. The trained estimators may be applied on a client-side data store, such as on a user device, a client data store, a trusted cloud, etc. The trained estimators may operate on input data at inference. The trained estimators may output a sequential obfuscation which may be applied to the input data at inference. The trained estimators may operate at any appropriate point in a data stream (e.g., data pipeline) such as previously described.

As described above, method 300 (and/or the other methods and systems described herein) is configured to provide a generic framework for input obfuscation based on a transformer block.

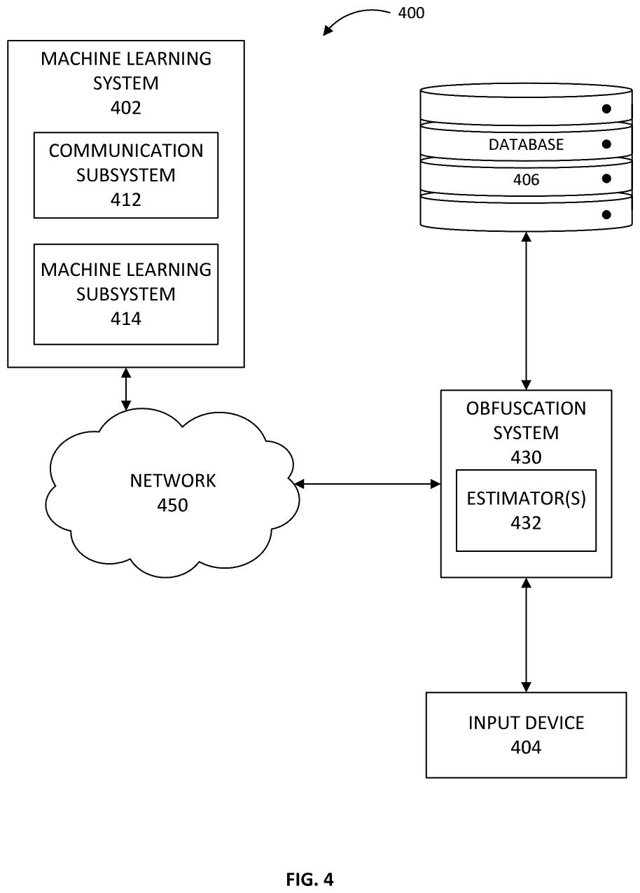

FIG. 4 shows an example computing system 400 for implementing data obfuscation in machine learning models, in accordance with some embodiments. The computing system 400 may include a machine learning (ML) system 402, an obfuscation system 430, a input device 404, and a database 406. The ML system 402 may include a communication subsystem 412, and a machine learning (ML) subsystem 414. The communication subsystem 412 may retrieve one or more datasets from the database 406 for use in training or performing inference via the ML subsystem 414 (e.g., using one or more machine-learning models described in connection with FIG. 1 and FIG. 2). The obfuscation system 430 may include one or more estimators 432. The estimators 432 may apply obfuscation to data transmitted to the ML system 402, such as from the input device 404 or the database 406. The obfuscation system 430 is depicted between the input device 404 and the database 406 and the network 450, but may be at any appropriate location, such as on a trusted network containing the input device 404 and the database 406.

One or more machine learning models used (e.g., for training or inference) by the ML subsystem 414 may include one or more transformers blocks. The ML subsystem 414 may be a foundation model, a LLM, a generative model, etc. The one or more obfuscated values (e.g., obfuscated output, encrypted output, encoded output, etc.) generated by the obfuscation system 430 may be used as input the ML system 402.

The estimators 432 may be trained via gradient descent (e.g., stochastic gradient descent) and backpropagation, or any other appropriate training methods, such as those previously described. One or more parameters may be trained, for example, because the one or more parameters are differentiable with respect to one or more other parameters of the machine learning model.

The input device 404, which may be a user device, may be one or more of a variety of different types of computing devices, including, but not limited to (which is not to suggest that other lists are limiting), a laptop computer, a tablet computer, a hand-held computer, smartphone, other computer equipment (e.g., a server or virtual server), including “smart,” wireless, wearable, Internet of Things device, or mobile devices. The input device 404 may be any device used by a healthcare professional (e.g., a mobile phone, a desktop computer used by healthcare professionals at a medical facility, etc.). The input device 404 may send commands or data to the obfuscation system 430. In some embodiments, the input device 404 may send commands or data to the ML system 402. Although only one input device 404 is shown, the system 400 may include any number of input devices.

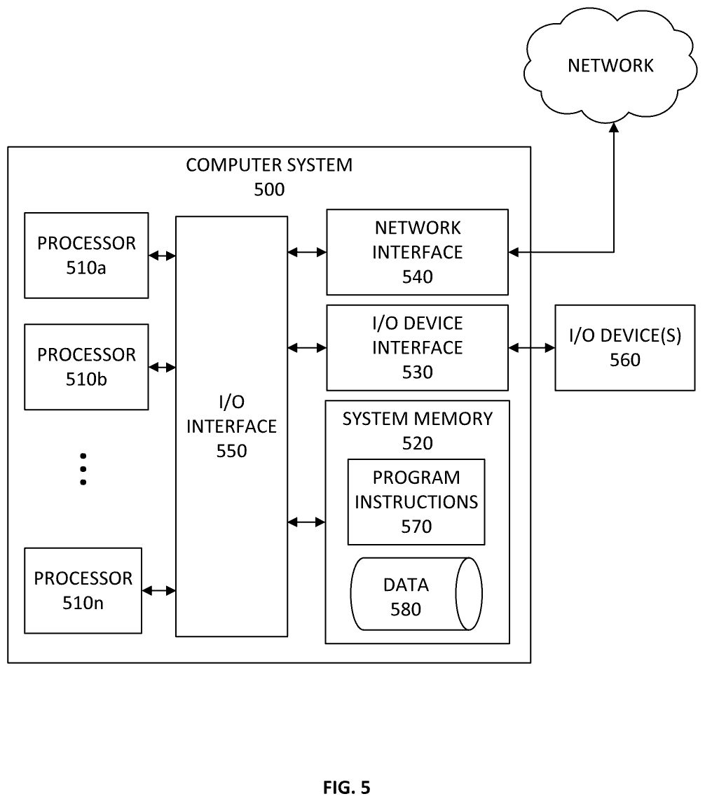

The ML system 402 may include one or more computing devices described above and may include any type of mobile terminal, fixed terminal, or any other computing device or system, such as will be described in relation to FIG. 5. For example, the ML system 402 may be implemented as a cloud computing system and may feature one or more component devices. Users may, for example, utilize one or more other devices to interact with devices, one or more servers, or other components of system 400. In some embodiments, operations described herein as being performed by particular components of the system 400, may be performed by other components of the system 400 (which is not to suggest that other features are not also amenable to variation). As an example, while one or more operations are described herein as being performed by components of the ML system 402, those operations may be performed by components of the input device 404 or database 406 or the obfuscation system 430. In some embodiments, the various computers and systems described herein may include one or more computing devices that are programmed to perform the described functions. In some embodiments, multiple users may interact with system 400. For example, a first user and a second user may interact with the ML system 402 and the obfuscation system 430 using two different input devices.

One or more components of the ML system 402, obfuscation system 430, input device 404, and database 406, may receive content and other data via input/output (hereinafter “I/O”) paths. The one or more components of the ML system 402, obfuscation system 430, the input device 404, and/or the database 406 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the ML system 402, obfuscation system 430, the input device 404, and the database 406 may have neither user input interface nor displays and may instead receive and display content using another device (e.g., a dedicated display device such as a computer screen and/or a dedicated input device such as a remote control, mouse, voice input, etc.). Additionally, the devices in system 400 may run an application (or another suitable program). The application may cause the processors and other control circuitry to perform operations related to weighting training data (e.g., to increase the efficiency of training and performance of one or more machine-learning models described herein).

One or more components or devices in the system 400 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically, magnetically, or optically readable storage media. The electronic storages may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 4 also includes a network 450. The network 450 may be the Internet, a mobile phone network, a mobile voice or data network (e.g., a 5G or LTE network), a cable network, a public switched telephone network, a combination of these networks, or other types of communications networks or combinations of communications networks. The devices in FIG. 4 (e.g., the ML system 402, the obfuscation system 430, the input device 404, and/or the database 406) may communicate (e.g., with each other or other computing systems not shown in FIG. 4) via the network 450 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 4 may include additional communication paths linking hardware, software, and/or firmware components operating together. For example, the ML system 402, any component of the ML system 402 (e.g., the communication subsystem 412 or the large ML subsystem 414), the obfuscation system 430 and any of estimators 432 of the obfuscation system 430, the input device 404, and/or the database 406 may be implemented by one or more computing platforms.

In some embodiments, the machine-learning models may include a Bayesian network, such as a dynamic Bayesian network trained with Baum-Welch or the Viterbi algorithm. Other models may also be used to account for the acquisition of information over time to predict future events, e.g., various recurrent neural networks, like long-short-term memory models trained on gradient descent after loop unrolling, reinforcement learning models, and time-series transformer architectures with multi-headed attention. In some embodiments, some or all of the weights or coefficients of models described herein may be calculated by executing a machine learning algorithm on a training set of historical data. Some embodiments may execute a gradient descent optimization to determine model parameter values. Some embodiments may construct the model by, for example, assigning randomly selected weights; calculating an error amount with which the model describes the historical data and a rate of change in that error as a function of the weights in the model in the vicinity of the current weight (e.g., a derivative, or local slope); and incrementing the weights in a downward (or error reducing) direction. In some cases, these steps may be iteratively repeated until a change in error between iterations is less than a threshold amount, indicating at least a local minimum, if not a global minimum. To mitigate the risk of local minima, some embodiments may repeat the gradient descent optimization with multiple initial random values to confirm that iterations converge on a likely global minimum error. Other embodiments may iteratively adjust other machine learning models to reduce the error function, e.g., with a greedy algorithm that optimizes for the current iteration. The resulting, trained model, e.g., a vector of weights or thresholds, may be stored in memory and later retrieved for application to new calculations on newly calculated aggregate estimates.

In some cases, the amount of training data may be relatively sparse. This may make certain models less suitable than others. In such cases, some embodiments may use a triplet loss network or Siamese networks to compute similarity between out-of-sample records and example records in a training set, e.g., determining based on cosine distance, Manhattan distance, or Euclidian distance of corresponding vectors in an encoding space (e.g., with more than 5 dimensions, such as more than 50).

Run time may process inputs outside of a training set and may be different from training time, except for in use cases like active learning. Random selection includes pseudorandom selections. In some cases, the neural network may be relatively large, and the portion that is non-deterministic may be a relatively small portion. The neural network may have more than 10, 50, or 500 layers, and the number of stochastic layers may be less than 10, 5, or 3, in some cases. In some cases, the number of parameters of the neural network may be greater than 10,000; 100,000; 1,000,000; 10,000,000; 10,000,000,000, or even more; while the number of stochastic parameters may be less than 10%, 5%, 1%, or 0.1% of that. This is expected to address problems that arise when traditional probabilistic neural networks attempt to scale, which with many approaches, produces undesirably excessive scaling in memory or run time complexity. Other benefits expected of some embodiments include enhanced interpretability of trained neural networks based on statistical parameters of trained stochastic layers, the values of which may provide insight (e.g., through visualization, like by color coding layers or components thereof according to values of statistical parameters after training) into the contribution of various features in outputs of the neural network, enhanced privacy from injecting noise with granularity into select features or layers of the neural network making downstream layers our outputs less likely to leak information, and highlighting layers or portions thereof for pruning to compress neural networks without excessively impairing performance by removing those components that the statistical parameters indicate are not contributing sufficiently to performance. In some cases, the stochastic layers may be partially or fully constituted of differential parameters adjusted during training, which is expected to afford substantial benefits in terms of computational complexity during training relative to models with non-differentiable parameters. That said, embodiments are not limited to systems affording all of these benefits, which is not to suggest that any other description is limiting.

FIG. 5 is a diagram that illustrates an exemplary computing system 500, in accordance with some embodiments. Various portions of systems and methods described herein may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an input/output (I/O) device interface 530, and a network interface 540 via an input/output (I/O) interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 520). Computing system 500 may be a units-processor system including one processor (e.g., processor 510a), or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 500 may include a plurality of computing devices (e.g., distributed computer systems) to implement various processing functions.

I/O device interface 530 may provide an interface for connection of one or more I/O devices 560 to computing system 500. I/O devices may include devices that receive input (e.g., from a user) or output information (e.g., to a user). I/O devices 560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computing system 500 through a wired or wireless connection. I/O devices 560 may be connected to computing system 500 from a remote location. I/O devices 560 located on remote computer system, for example, may be connected to computing system 500 via a network and network interface 540.

Network interface 540 may include a network adapter that provides for connection of computing system 500 to a network. Network interface 540 may facilitate data exchange between computing system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 570 or data 580. Program instructions 570 may be executable by a processor (e.g., one or more of processors 510a-510n) to implement one or more embodiments of the present techniques. Program instructions 570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 520 may include a non-transitory computer readable storage medium that may have program instructions stored thereon that are executable by a computer processor (e.g., one or more of processors 510a-510n) to cause the subject matter and the functional operations described herein. A memory (e.g., system memory 520) may include a single memory device and/or a plurality of memory devices (e.g., distributed memory devices).

I/O interface 550 may be configured to coordinate I/O traffic between processors 510a-510n, system memory 520, network interface 540, I/O devices 560, and/or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 500 or multiple computer systems 500 configured to host different portions or instances of embodiments. Multiple computer systems 500 may provide for parallel or sequential processing/execution of one or more portions of the techniques described herein.

Those skilled in the art will appreciate that computing system 500 is merely illustrative and is not intended to limit the scope of the techniques described herein. Computing system 500 may include any combination of devices or software that may perform or otherwise provide for the performance of the techniques described herein. For example, computing system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 500 may be transmitted to computing system 500 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

As data storage and analysis costs decrease (such as due to storage unit cost decrease, processing cost decrease, increased use of cloud computing, transmission speed increases, etc.), data collection by various entities (e.g., service providers, public safety entities, commercial enterprises, etc.) has increased, leading to generation of large troves of information, which may be referred to as “big data”. The data may exist in many forms: visual (e.g., image data), textual (e.g., language), tabular (e.g., columnar, spreadsheet, etc.), including in multiple forms within a single data collection. Rapid scaling of AI, including deep neural networks, has enabled entities to extract high value from data stores, such as by predictive customer churn, through generative modeling, etc. However, much of the data collected may contain highly sensitive information, such as facial images, public health information (PHI), etc. An entity may have obligations (legal, contractual, moral, etc.) to protect such sensitive information, including obligations to keep such data private or otherwise safe from access or dissemination. A transform that would protect the information in a model, including an untrusted model, while allowing value to be extracted from the data collection would allow an entity to operate a model, such as a foundation model, which is maintained by another entity for its own ends. More value may be extracted from more granular data, which may be less obfuscated—that is, there may be a tradeoff between value extraction and data privacy which may be adjusted.

In some embodiments, a Foundation Model (also referred to as a foundational model) is used. In some embodiments, a generative model is used. In some embodiments, any appropriate model, including a pre-trained model, is used. In some embodiments, self-supervised learning is used, for example, for an autoencoder. A formulation may be developed which may provide a method for obfuscating output data (including sensitive data), which may be a method for generating obfuscating layers, which may be applied at any appropriate juncture in the machine learning model, such as on input data, within the machine learning model, on embeddings, etc. In some embodiments, given a foundation model that generates representations of the source data (e.g., the input data, the data of the data collection, or another data store), a transformation, may be learned (e.g., trained) which is a substantially significant transform (e.g., obfuscating) in the output space (e.g., on the output data of the foundation) but which is less significant or null in the input space (e.g., in the input space of or on the input data to the foundation model). In some embodiments, separate obfuscation operations may be performed on input data and output data, including obfuscation operations on output data generated by the machine learning model from obfuscated input data. These transforms may generate data (or other outputs) which are valuable for data inference, modeling, training, etc. purposes while maintaining data privacy, including by application of homomorphic encryption. This framework may be applied to a variety of data types, including but not limited to vision, text, and tabular datasets.

Some embodiments, such as the some of those presently discussed, may provide value to both the owners of the data (e.g., such that data owners may continue to provide data to the data collection and transform while protecting data) and owners of the model (e.g., entities that may license models and may have obligations to prevent spillover, maintain client privacy, etc.). By ensuring privacy of the output of the model, the model-owners may increase their customer base, ensuring that model-users may be able to guarantee privacy of data even in distributed model systems. Data owners may be incentivized to continue to contribute to a model, such as by payment of access fees or royalties, by supplying of data, etc., as long as they are issued guarantees on the privacy of their data (e.g., from release from the data store, from data spillover, etc.).

A foundation model may be any model that is trained on substantially broad data that may be adapted to a wide range of downstream tasks. This term may include techniques such as pre-training (on unstructured data) and fine-tuning (on downstream tasks). Although these terms describe these models at a technical level, the term foundation may capture the paradigm shift in deployment of foundation models. Foundation models may now more effectively capture useful statistics in the data, and may work on a much larger group of tasks.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to cost constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A method comprising:
obtaining, by a computer system, a machine learning model, the machine learning model comprising at least one transformer block;
generating, by the computer system, one or more estimator based on the at least one transformer block,
wherein at least one estimator comprises a mean shift estimator; and
wherein at least one estimator comprises a dispersion shift estimator;
training, by the computer system, the one or more estimators to obfuscate input data for the machine learning model; and
storing, by the computer system, the trained one or more estimators in memory.

2. The method of claim 1, wherein the mean shift estimator applies a deterministic mean shift.

3. The method of claim 1, wherein the dispersion shift estimator applies a stochastic based on a sequence-dependent measure of dispersion.

4. The method of claim 1, wherein training the one or more estimators comprises training the one or more estimators by an optimization function.

5. The method of claim 4, wherein the optimization function comprises a first portion corresponding to a maximization of noise applied by at least some of the one or more estimators.

6. The method of claim 4, wherein the optimization function comprises a second portion corresponding to a minimization of a performance loss for the machine learning model operating on obfuscated data output by the estimators.

7. The method of claim 1, wherein training the one or more estimators further comprises:
generating a student machine learning model, the student machine learning model comprising the one or more estimators;
generating a teacher machine learning model, the teacher machine learning model not comprising the one or more estimators; and
training the one or more estimators by an optimization function based on the student machine learning model and the teacher machine learning model.

8. The method of claim 7, wherein the optimization function comprises a similarity optimization function between the student machine learning model and the teacher machine learning model.

9. The method of claim 7, wherein the optimization function comprises a distance distillation optimization function between the student machine learning model and the teacher machine learning model.

10. The method of claim 7, wherein at least one of the student machine learning model and the teacher machine learning model comprises a truncated machine learning model.

11. The method of claim 7, wherein the optimization function comprises a third portion corresponding to a minimization of a performance loss for the machine learning model operating on obfuscated data output by the estimators.

12. The method of claim 1, wherein the one or more estimators are substantially the same as the at least one transformer block.

13. The method of claim 1, wherein at least one of the one or more estimators is non-causal.

14. The method of claim 1, wherein an attention mechanism of at least one of the one or more estimators is different than an attention mechanism of the transformer block.

15. The method of claim 1, wherein a flow mechanism of at least one of the one or more estimators is different than a flow mechanism of the transformer block.

16. The method of claim 1, wherein the one or more estimators operate on embeddings corresponding to input data for the machine learning model.

17. The method of claim 1, further comprising deploying, within a trusted network, the trained one or more estimators to obfuscate input data, wherein the obfuscated input data is transmitted to the machine learning model over an untrusted network.

18. The method of claim 1, wherein training the one or more estimators comprises training the one or more estimators with the machine learning model on a trusted network, the method further comprising deploying the trained one or more estimators to provide obfuscated input data to the machine learning model over an untrusted network.

19. A system comprising:
memory, the memory configured to store:
a machine learning model, the machine learning model configured to produce output data based on input data; and
an obfuscation system, the obfuscation system configured to obfuscate input data provided to the machine learning model; and
a processor, the processor configured to train one or more estimators of the obfuscation system by:
obtaining at least one transformer block from the machine learning model;
generating one or more estimator based on the at least one transformer block,
wherein at least one estimator comprises a mean shift estimator; and
wherein at least one estimator comprises a dispersion shift estimator;
training the one or more estimators to obfuscate input data for the machine learning model; and
storing the trained one or more estimators in memory.

20. The system of claim 19, further comprising an input device, wherein the obfuscation system is configured to obfuscate input data from the input device.
